(19) United States
(12) Patent Application Publication
(10) Pub. No.: US 2006/0195478 A1
(43) Pub. Date: Aug. 31, 2006

(54) Method and apparatus for seeking a part of media contents included in multimedia contents

(75) Inventors: Ju-han Lee, Suwon-si (KR); Ji-hoon Kim, Hwaseong-si (KR); In-hwan Kim, Suwon-si (KR); Seung-gi Chang, Seoul (KR); Ho-Jeong You, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/303,988

(22) Filed: Dec. 19, 2005

(30) Foreign Application Priority Data
Feb. 26, 2005 (KR) 10-2005-0016261

(51) Int. Cl. G06F 7/00

(52) U.S. Cl. 707/104.1

(57) ABSTRACT

Provided are a method of providing media contents in a wired/wireless network environment and an apparatus using the same. The method includes: detecting a start point of media contents included in multimedia contents from the multimedia contents; and extracting a part of media contents based on the detected start point. Thus, the part of media contents can be provided to a digital media client in real time transcoding in which it is difficult to calculate the far end point of media contents.

### BACKGROUND OF THE INVENTION

This application claims the benefit of Korean Patent Application No. 10-2005-0016261, filed on Feb. 26, 2005, in the Korean Intellectual Property Office, the disclosure of which is incorporated herein in its entirety by reference.

1. Field of the Invention

The present invention relates to a method of providing media contents in a wired/wireless network environment and an apparatus using the same.

2. Description of the Related Art

Many electronic appliance manufacturers joined to form a digital living network alliance (DLNA) to secure seamless multimedia contents transfer between consumer electronics (CE), personal computers (PC), mobile terminals, etc. in a wired/wireless network environment.

In particular, home networked device interoperability guidelines version 1.0 (HNv1) suggested by the DLNA (hereinafter referred to as “DLNA HNv1”) specifies communication between a digital media server and a digital media client. According to the DLNA HNv1, an Internet protocol (IP) is used as a network layer protocol, a transmission control protocol (TCP) is used as a transmission layer protocol, and a hypertext transfer protocol (HTTP) is used as an application layer protocol.

The DLNA HNv1 specifies that the digital media client can request a part of media contents from the digital media server and in response, the digital media server can transfer the part of media contents. The following is an example of code used by the digital media client to request a part of media contents in unit of bytes for resource of BigFile.html. As indicated below, the digital media client can designate the range of URLs to be received using a range field included in a HTTP header.

GET BigFile.html HTTP/1.1

HOST: www.samsung.com

Range: 2000-3999

The following is an example of code used by the digital media server to transfer a part of media contents using the HTTP in response to the request from the digital media client.

HTTP/1.1 206 Partial Content

Date: Sun, 28 Nov. 2004 16:25:22 GMT

Content-Range: bytes 2000-3999/100000

Content-Length: 2000

Content-Type: text/html

However, the DLNA HNv1 specifies that the digital media client cannot request a part of media contents from the digital media server when the digital media server provides a live stream without understanding far-end of media contents or performs a real time transcoding without calculating the far end point of media contents, because it is impossible to know the length of media contents, which makes it difficult or impossible to understand the part of media contents.

Multimedia contents recorded on a general purpose digital versatile disc (DVD) contain media contents composed of MPEG-2 program streams (PSs). However, since the multimedia contents recorded on the DVD contain navigation information for the MPEG-2 PSs, in addition to the MPEG-2 PSs, the digital media server reads the multimedia contents from the DVD and media contents are provided from the read multimedia contents, which is regarded as the real time transcoding.

Therefore, it is impossible to request a part of the media contents recorded on the DVD in a DLNA HNv1-based home network environment. The entire media contents recorded on the DVD must be transferred if a user wants to watch a part of the media contents recorded on the DVD, and the user must stand by until the entire media contents are completely received, which causes an inconvenience. Such an unnecessary data transfer also increases a network load.

### SUMMARY OF THE INVENTION

The present invention provides a method of providing a part of media contents to a digital media client using a real time transcoding without calculating a far end point of the part of media contents, and an apparatus using the same.

The present invention also provides a computer readable medium having embodied thereon a computer program for executing the method.

According to an aspect of the present invention, there is provided a method of providing a part of media contents, the method comprising: (a) parsing multimedia contents; (b) searching for the part of media contents included in the multimedia contents based on the result obtained through the parsing; and (c) transferring the part of media contents found in the searching.

According to another aspect of the present invention, there is provided a server comprising: a parsing unit parsing multimedia contents; a searching unit searching for a part of media contents included in the multimedia contents based on the result obtained by the parsing unit; and a transferring unit transferring the part of media contents found by the searching unit.

According to another aspect of the present invention, there is provided a computer-readable storage medium having embodied thereon a computer program for executing the method of providing a part of media contents.

According to another aspect of the present invention, there is provided a method of searching for a part of media contents, the method comprising: (a) detecting a start point of media contents included in multimedia contents from the multimedia contents; and (b) extracting the part of media contents based on the detected start point.

According to another aspect of the present invention, there is provided an apparatus for searching for a part of media contents, the apparatus comprising: a detecting unit detecting a start point of media contents included in multimedia contents from the multimedia contents; and an extracting unit extracting the part of media contents based on the detected start point.

According to another aspect of the present invention, there is provided a computer-readable storage medium having embodied thereon a computer program for executing the method of searching for a part of media contents.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of a home network system according to an embodiment of the present invention;

FIG. 2 illustrates a volume structure of a digital versatile disc (DVD);

FIG. 3 illustrates the structure of video manager (VMG) and video title set (VTS) regions shown in FIG. 2;

FIG. 4 illustrates the detailed structure of VTSTT_VOBS (VTS Title_VOBS) shown in FIG. 3;

FIG. 5 illustrates the detailed structure of VTSM_VOBU_ADMAP shown in FIG. 3;

FIG. 6 illustrates the detailed structure of a pack shown in FIG. 4;

FIG. 7 is a detailed block diagram of a partial searching unit shown in FIG. 1;

FIG. 8 is a flowchart of a method of providing a part of media contents according to an embodiment of the present invention; and

FIG. 9 is a flowchart of a method of searching for a part of media contents according to an embodiment of the present invention.

### DETAILED DESCRIPTION OF THE INVENTION

The present invention will now be described more fully with reference to the accompanying drawings.

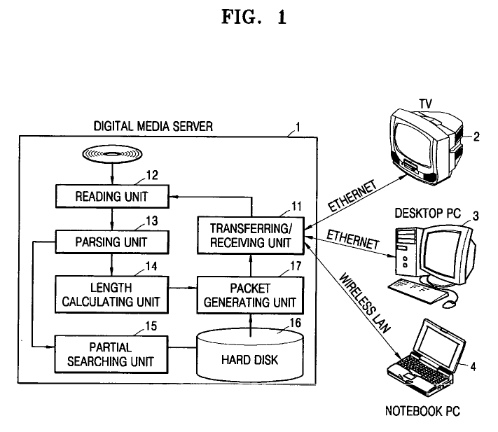

FIG. 1 is a schematic diagram of a home network system according to an embodiment of the present invention. Referring to FIG. 1, the home network system comprises a digital media server 1, a television (TV) 2 corresponding to a digital media client, a desktop personal computer (PC) 3, and a notebook PC 4 according to home networked device interoperability guidelines version 1.0 (HNv1) suggested by the DLNA (hereinafter referred to as “DLNA HNv1”).

According to the DLNA HNv1, the digital media server 1, the TV 2, the desktop PC 3, and the notebook PC 4 use an Internet protocol (IP) as a network layer protocol, a transmission control protocol (TCP) as a transmission layer protocol, and a hypertext transfer protocol (HTTP) as an application layer protocol. In particular, the digital media server 1, the TV 2, and the desktop PC 3 use Ethernet which is a kind of a wired LAN, as a link layer. The digital media server 1 and the notebook PC 4 use an Institute of Electrical and Electronics Engineers (IEEE) 802.11 wireless LAN as a link layer.

The digital media server 1 comprises a transferring/receiving unit 11, a reading unit 12, a parsing unit 13, a length calculating unit 14, a partial searching unit 15, a hard disk 16, and a packet generating unit 17.

The transferring/receiving unit 11 receives a request for a part of media contents from the TV 2 corresponding to the digital media client, the desktop PC 3, or the notebook PC 4. The transferring/receiving unit 11 transfers a packet generated by the packet generating unit 16 to a device for reproducing a part of the media contents, i.e., the TV 2 corresponding to the digital media client, the desktop PC 3, or the notebook PC 4, in response to the request by the digital media client.

According to the DLNA HNv1, the transferring/receiving unit 11 receives the request for a part of the media contents using the HTTP as follows:

GET BigFile.html HTTP/1.1

HOST: www.samsung.com

Range: 2000-3999

The transferring/receiving unit 11 transfers the part and the length of media contents using the HTTP as follows:

HTTP/1.1 206 Partial Content

Date: Sun, 28 Nov. 2004 16:25:22 GMT

Content-Range: bytes 2000-3999/100000

Content-Length: 2000

Content-Type: text/html

The reading unit 12 reads media contents and multimedia contents including information on the media contents from a digital versatile disc (DVD) when the transferring/receiving unit 11 receives the request for a part of the media contents. The media contents may be referred to as video data, and may include audio data, image data, etc. In particular, according to the DLNA HNv1, video data is composed of moving picture experts group (MPEG)-2 program streams (PSs).

The parsing unit 13 parses the multimedia contents read by the reading unit 12, thereby recognizing a recording structure of the multimedia contents. The recording structure of the multimedia contents on the DVD will be described below.

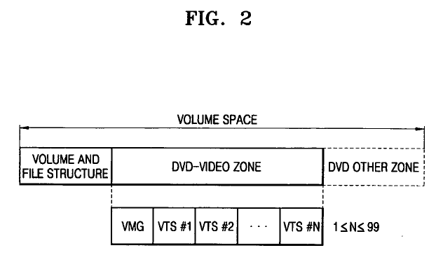

FIG. 2 illustrates a volume structure of the DVD. Referring to FIG. 2, the volume space of the DVD is composed of a volume/file structure region on which data is recorded in a universal disc format (UDF) bridge structure, a DVD video region on which video data is recorded, and other regions. To be more specific, the DVD video region includes a video manager (VMG region) on which control information necessary for reproducing video data is recorded and one to ninety-nine video title set (VTS) regions.

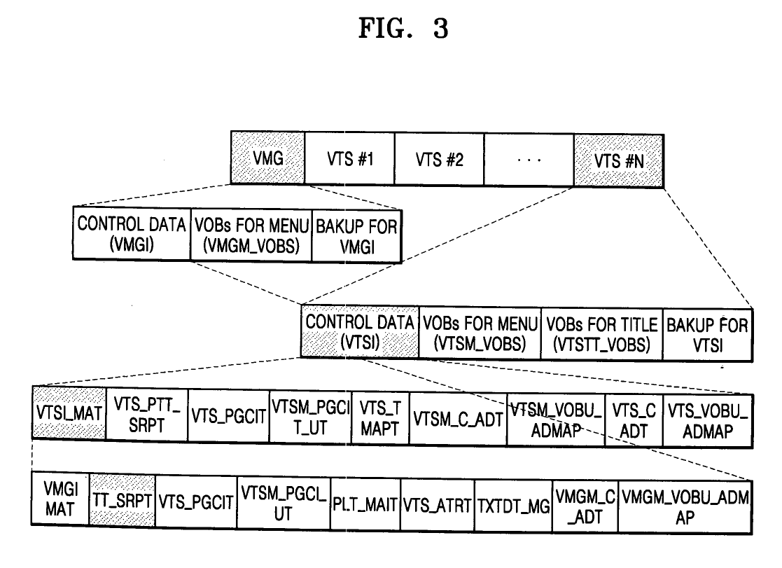

FIG. 3 illustrates the structure of the VMG and the VTS regions shown in FIG. 2. Referring to FIG. 3, the VMG region comprises video manager information (VMGI), a video manager menu_video object set (VMGM_VOBS), and a VMGI backup. To be more specific, the VMG region comprises VMGI_MAT(VMGI_Management Table), TT_SRPT(Title_Search Pointer Table), VTS_PGCIT(VTS_Program Chain Information Table), VMGM_PGCI_UT(VMGM_Program Chain Information_Unit Table), PLT_MAIT(Parental_Management Information Table), VTS_ATRT(VTS_Attribute Table), TXTDT_MG(Text Data_Manager), VMGM_C_ADT(VMGM_Cell_Address Table), VMGM_VOBU_ADMAP(VMGM_Video Object Unit_Address Map).

The VTS comprises VTSI (VTS Information), VTSM_VOBS (VTS Menu_VOBS), VTSTT_VOBS (VTS Title_VOBS), and a VTSI backup. To be more specific, the VTSI comprises a VTSI_MAT (VTS Information Management Table), VTS_PTT_SRPT (VTS_Part Title_SRPT), VTS_PGCIT, VTSM_PGCIT_UT, VTS_TMAPT (VTS_Time Table Map), VTSM_C_ADT, and VTSM_VOBU_ADMAP. The media contents are recorded in the VTSTT_VOBS.

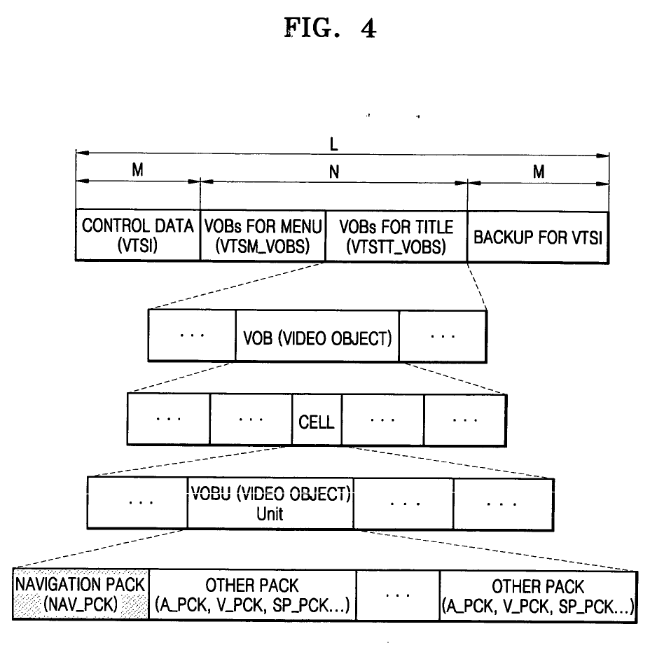

FIG. 4 illustrates the detailed structure of the VTSTT_VOBS shown in FIG. 3. Referring to FIG. 4, the VTSTT_VOBS comprises a plurality of VOBs (Video Objects). Each of the plurality of VOBs comprises a plurality of cells, and each of the plurality of cells comprises a plurality of VOBUs. Each of the plurality of VOBUs comprises navigation packs and packs to which media contents are recorded. As shown in FIG. 4, one VOBU must include one navigation pack to which the media contents are not recorded. Therefore, the length of the media contents can be calculated by subtracting the length of navigation packs multiplied by the number of the plurality of VOBUs from the length of the VOB.

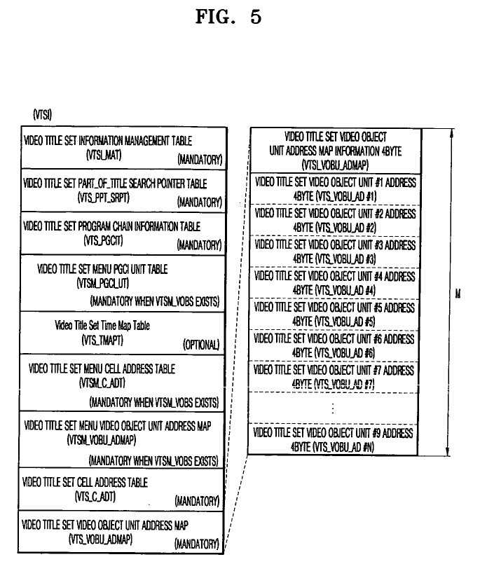

FIG. 5 illustrates the detailed structure of the VTSM_VOBU_ADMAP shown in FIG. 3. Referring to FIG. 5, the VTSM_VOBU_ADMAP comprises VTSM_VOBU_ADMAPI(VTSM_VOBU_ADMAP Information) and n VTS_VOBU_AD(VTS_VOBU_Address).

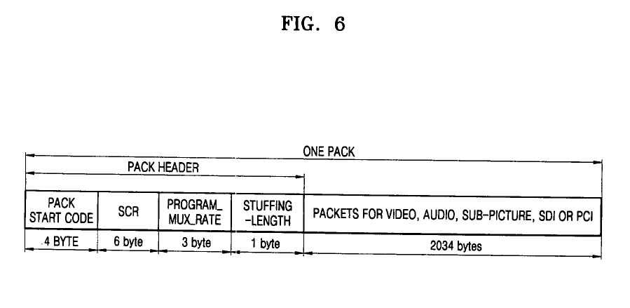

FIG. 6 illustrates the detailed structure of one of the packs shown in FIG. 4. Referring to FIG. 6, each of the packs constituting the VOBU comprises pack start code, SCR (System Clock Reference), a program mux_rate, a stuffing length, and packets for video, audio, sub pictures, DSI (Data Search Information), and PCI (Presentation Control Information).

The length calculating unit 14 calculates the length of the media contents included in multimedia contents based on the result obtained through the parsing in the parsing unit 13. To be more specific, the length calculator 14 calculates the length of the media contents recorded on the DVD video region based on information recorded to the DVD video region obtained through the parsing in the parsing unit 13.

The length calculator 14 calculates the length of each of the VTSs included in the information recorded to the DVD video region. Each start point of the VTSs is recorded to the TT_SRPT and each end point of the VTSs is recorded to the VTSI_MAT as shown in FIG. 3. That is, the length calculator 14 calculates the length of each of the VTSs by subtracting the start point of each of the VTSs recorded to the TT_SRPT from the end point of the VTS recorded to the VTSI_MAT.

The length calculator 14 calculates the length of each of the VTSIs from the start point of each of the VTSs and the end point of each of the VTSIs among the information recorded to the DVD video region. The start point of each of the VTSs is recorded to the TT_SRPT and the end point of each of the VTSIs is recorded to the VTSI_MAT as shown in FIG. 3. That is, the length calculator 14 calculates the length of each of the VTSIs by subtracting the start point of each of the VTSs recorded to the TT_SRPT from the end point of each of the VTSIs recorded to the VTSI_MAT.

The length calculator 14 calculates the length of the VOB from the calculated lengths of the VTSs and the VTSIs as follows:
N=(L−2×M)×2048 (1)

Referring to FIG. 4, L denotes the length of each of the VTSs, M denotes the length of each of the VTSIs, and N denotes the length of the VOB. The length calculator 14 subtracts M twice from L and multiplies the subtracted value by 2048 to calculate the length of the VOB. The units of N are bytes and the units of L and M are sectors. 2048-byte which is the length of a sector of the DVD is multiplied to (L−2×M). When a temporary file is burned to the DVD, since a file is allocated to a VTS and the VTS does not include the VTSM_VOBS, the length of the VTSM_VOBS is not considered in the present embodiment. Those having ordinary skill in the art can easily calculate the length of the VOB based on the length of the VTSM_VOBS.

The length calculator 14 calculates the length of the VTS_VOBU_ADMAP of each of the VTSIs included in the information recorded on the DVD video region. The start point of the VTS_VOBU_ADMAP of each of the VTSIs and the end point of the VTS_VOBU_ADMAP are recorded to the VTSI_MAT as shown in FIG. 3. That is, the length calculator 14 calculates the length of VTS_VOBU_ADMAP of each of the VTSIs by subtracting the start point of the VTS_VOBU_ADMAP of each of the VTSIs recorded on the VTSI_MAT from the end point of VTS_VOBU_ADMAP recorded to the VTSI_MAT.

The length calculator 14 calculates the number of the VOBs from the calculated lengths of the VTS_VOBU_ADMAP and the VTS_VOBU_ADMAPI as follows:
N=(M−4)/4 (2)

Referring to FIG. 5, M denotes the length of the VTS_VOBU_ADMAP and 4 is the length of the VTS_VOBU_ADMAPI. The length of each of the N VTS_VOBU_ADs is all 4 bytes. Since the number of the VTS_VOBU_ADs is identical to that of the VOBUs, the length calculator 14 calculates the length of the VOBUs by subtracting 4 from M and dividing the subtracted value by 4.

The length calculator 14 calculates the total length of navigation packs included in each of the VOBUs from the calculated number of VOBUs. Since the length of each of the navigation packs is 2048 bytes, the length calculator 14 calculates the total length of navigation packs included in each of the VOBUs by multiplying the number of VOBUs by 2048.

The length calculator 14 calculates the length of the media contents from the calculated length of the VOBUs and the total length of the navigation packs. To this end, the length calculator 14 subtracts the total length of the navigation packs from the calculated length of the VOBUs to calculate the length of the media contents.

The partial searching unit 15 searches for a part of media contents in the multimedia contents based on the result obtained through the parsing performed by the parsing unit 13. The partial searching unit 15 searches for a part of media contents recorded on the DVD video region based on information recorded on the DVD video region of the DVD obtained through the parsing performed by the parsing unit 13.

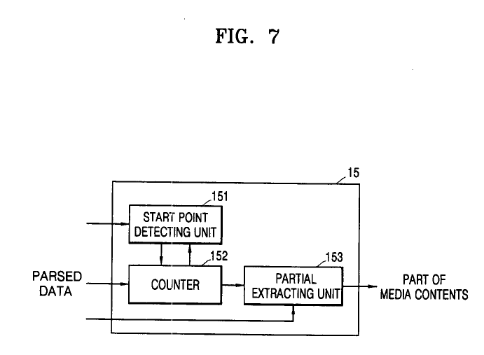

FIG. 7 is a detailed block diagram of the partial searching unit 15 shown in FIG. 1. Referring to FIG. 7, the partial searching unit 15 comprises a start point detecting unit 151, a counter 152, and a partial extracting unit 153.

The start point detecting unit 151 detects a start point of media contents included in multimedia contents from the multimedia contents based on end points of the VTSIs among the information recorded on the DVD video region. Referring to FIG. 4, since the media contents are recorded in packs constituting the VOBU besides the navigation pack and the length of the VTSM_VOBS is not considered in the present embodiment, the start point of the VOB including the VOBUs is identical to the end point of the VTSI. Therefore, the start point detecting unit 151 can detect the start point of the media contents based on the end points of the VTSIs recorded to the VTSI_MAT shown in FIG. 3.

Referring to FIG. 6, each of the packs constituting the VOBU has a predetermined length of 2048 bytes. A pack start code indicating that the packs to which the media contents are recorded relate to the media contents is recorded in a first 4 bytes. The start point detecting unit 151 detects the pack start code from the packs constituting the VOBU, thereby detecting the start point of the media contents.

The start point detecting unit 151 determines whether the start point of the media contents is detected in a pack immediately after a point where the counter 152 stops counting. Therefore, the start point detecting unit 151 detects the start point of the media contents from the pack immediately after the point where the counter 152 stops counting.

The counter 152 counts from the start point detected by the start point detecting unit 151 to a start point of a part of media contents, and counts from the start point of the part of media contents to an end point of the part of media contents.

As described above, if the transferring/receiving unit 11 receives a request of Content-Range:2000-3999, the counter 152 counts from the start point detected by the start point detecting unit 151 to a point corresponding to 2000 bytes, and counts from the point corresponding to 2000 bytes to a point corresponding to 3999 bytes.

Since the packs constituting the VOBU each have the predetermined length of 2048 bytes, when the length from the start point detected by the start point detecting unit 151 to the start point of a part of the media contents or the length of a part of the media contents exceeds 2048 bytes, the counter 152 finishes counting a current pack without finishing counting to the end point of a part of media contents. In this case, the counter 152 stops counting since it is not clear whether subsequent packs are those relating to the media contents and must inquire the start point detecting unit 151 of whether the start point of the media contents is detected in the subsequent packs.

The counter 152 receives the start point detected by the start point detecting unit 151 in response to the inquiry whether the start point of the media contents is detected and keeps counting from the start point. The detecting of the start point in the start point detecting unit 151 and the counting in the counter 152 are repeatedly performed until arriving at the end point of the part of media contents.

The partial extracting unit 153 extracts the part of media contents from the multimedia contents based on the start point detected by the start point detecting unit 151. The partial extracting unit 153 extracts the counted portion from the multimedia contents whenever the counter 152 counts. As the detecting of the start point by the start point detecting unit 151 and the counting by the counter 152 are repeatedly performed, the partial extracting unit 153 extracts data from the start point to the end point of the part counted by the counter 152.

Referring to FIG. 1, the hard disk 16 stores a part of media contents found by the partial searching unit 1. To be more specific, the hard disk 16 stores the media contents extracted by the partial extracting unit 153 according to the counting performed by the counter 152. As a result, if the counter 152 counts to the end point of the part of media contents, the part extracted by the partial extracting unit 153 is stored in the hard disk 16.

The packet generating unit 17 generates headers in which the length of the media contents calculated by the calculating unit 13 is recorded and packets including a payload to which the part of media contents is recorded. According to the DLNA HNv1, the packet generating unit 17 generates headers including an IP header, a TCP header, and a HTTP header. In particular, the length of the media contents is recorded in the HTTP header.

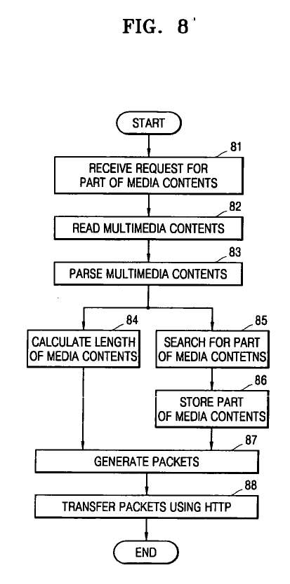

FIG. 8 is a flowchart of a method of providing a part of media contents according to an embodiment of the present invention. Referring to FIG. 8, the method of providing the part of media contents is performed by the digital media server 1 shown in FIG. 1 on the basis of time series. Therefore, the technical contents relating to the digital media server 1 are applied to the method of providing the part of media contents.

In Operation 81, the digital media server 1 receives a request for a part of the media contents from the TV 2 corresponding to the digital media client, the desktop PC 3, or the notebook PC 4.

In Operation 82, the digital media server 1 reads the media contents and multimedia contents including information on the media contents from a DVD.

In Operation 83, the digital media server 1 parses the multimedia contents read in Operation 82 and recognizes the recording structure of the multimedia contents.

In Operation 84, the digital media server 1 calculates the length of the media contents included in the multimedia contents based on the result obtained through the parsing in Operation 83. To be more specific, the digital media server 1 calculates the length of the media contents recorded on a DVD video region based on information recorded in the DVD video region that is parsed in Operation 83.

In Operation 85, the digital media server 1 searches for a part of media contents included in the multimedia contents based on the result obtained through the parsing in Operation 83. The digital media server 1 searches for a part of media contents recorded in the DVD video region based on information recorded on the DVD video region obtained through the parsing in Operation 83.

In Operation 86, the digital media server 1 stores the part of a part of media contents obtained through the searching in Operation 85.

In Operation 87, the digital media server 1 generates headers on which the length of the media contents obtained through the calculating in Operation 84 is recorded and packets including a payload in which a part of media contents stored in Operation 86 is recorded. According to the DLNA HNv1, the packet generating unit 17 generates headers including an IP header, a TCP header, and a HTTP header. In particular, the length of the media contents is recorded in the HTTP header.

In Operation 88, the digital media server 1 transfers the packet generated in Operation 87 to a device for reproducing a part of media contents, i.e., the TV 2 corresponding to the digital media client, the desktop PC 3, or the notebook PC 4. According to the DLNA HNv1, the digital media server 1 transfers the media contents and the length of the media contents using the HTTP.

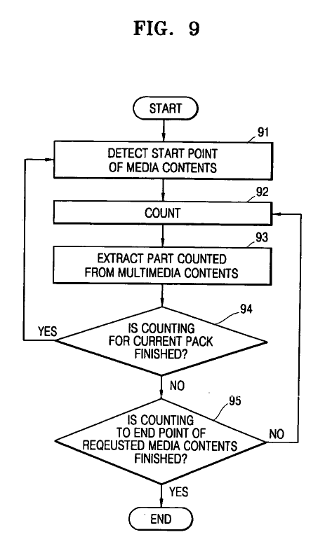

FIG. 9 is a flowchart of a method of searching for a part of media contents according to an embodiment of the present invention. Referring to FIG. 9, the method of searching for the part of media contents is performed in the partial searching unit 15 shown in FIG. 7 on the basis of time series. Therefore, the technical contents relating to the partial searching unit 15 are applied to the method of providing the part of media contents.

In Operation 91, the partial searching unit 15 detects a start point of the media contents included in multimedia contents based on the end point of each of a plurality of VTSIs among information recorded in a DVD video region. To be more specific, the partial searching unit 15 detects pack start code indicating that packs constituting a VOBU are those relating to the media contents, thereby detecting the start point of the media contents.

In Operation 92, the partial searching unit 15 counts from the start point detected in Operation 91 to a start point of a part of media contents and counts from the start point of a part of media contents to an end point of a part of media contents.

In Operation 93, the partial searching unit 15 extracts contents from the start point of a part of media contents to the end point of a part of media contents counted in Operation 92.

In Operation 94, the partial searching unit 15 determines whether the counting of a current pack is finished and, if the counting is determined to be finished, the partial searching unit 15 returns to Operation 91.

In Operation 95, if the counting of the current pack is determined not to be finished, the partial searching unit 15 determines whether the counting to the end point of a part of media contents is finished and, if the counting is determined not to be finished, the partial searching unit 15 returns to Operation 92.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves.

The present invention can provide a part of media contents to a digital media client when performing real time transcoding in which it is difficult to calculate the far end point of media contents, e.g. when a digital media server reads multimedia contents from a DVD and provides media contents from the multimedia contents. Therefore, the digital media client is provided with the part of media contents of the media contents including MPEG-2 PS from the digital media server, thereby overcoming the inconvenience that a user must endure while completely receiving the entire media contents, and reducing network load due to an unnecessary transfer of data in a home network environment according to DLNA HNv1.

While the present invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of providing a part of media contents, the method comprising:
(a) parsing multimedia contents;
(b) searching for the part of media contents included in the multimedia contents based on the result obtained through the parsing; and
(c) transferring the part of media contents found in the searching.

2. The method of claim 1, wherein operation (b) comprises searching for the part of media contents based on information on the media contents.

3. The method of claim 2, wherein:
the multimedia contents are recorded on a DVD (Digital Versatile Disc), and
operation (b) comprises searching for the part of media contents recorded in a DVD video region of the DVD based on information recorded in the DVD video region.

4. The method of claim 1, further comprising: calculating the length of the media contents included in the multimedia contents based on the result obtained through the parsing,
wherein operation (c) comprises transferring the part of media content and the calculated length of the part of media contents using a HTTP (Hypertext Transfer Protocol).

5. The method of claim 4, further comprising: generating headers in which the length of the part of media contents is recorded and packets in which the part of media contents is recorded,
wherein operation (c) comprises transferring the generated packets to a device for reproducing the part of media contents.

6. The method of claim 1, further comprising: receiving a request for the part of media contents from a digital media client,
wherein operation (c) comprises transferring the part of media contents to the digital media client in response to the request.

7. A server comprising:
a parsing unit parsing multimedia contents;
a searching unit searching for a part of media contents included in the multimedia contents based on the result obtained by the parsing unit; and
a transferring unit transferring the part of media contents found by the searching unit.

8. The sever of claim 7, wherein the searching unit searches for the part of media contents based on information on the media contents.

9. The sever of claim 7, further comprising: a calculating unit calculating the length of the media contents included in the multimedia contents based on the result obtained by the parsing unit,
wherein the transferring unit transfers the part of media content and the calculated length of the part of media contents using an HTTP.

10. A computer-readable storage medium having embodied thereon a computer program for executing a method of providing a part of media contents, the method comprising:
parsing multimedia contents;
searching for the part of media contents included in the multimedia contents based on the result obtained through the parsing; and
transferring the part of media contents found in the searching.

11. A method of searching for a part of media contents, the method comprising:
(a) detecting a start point of media contents included in multimedia contents from the multimedia contents; and
(b) extracting the part of media contents based on the detected start point.

12. The method of claim 11, further comprising: counting from the detected start point of media contents to a start point of the part of media contents, and then counting from the start point of the part of media contents to an end point of the part of media contents,
wherein operation (b) comprises extracting from the counted start point of the part of media contents to the counted end point of the part of media contents.

13. The method of claim 12, wherein:
the media contents comprise packs having a predetermined length, and operation (b) comprises:
stopping counting when a counting of a first pack among the packs is finished in a state where counting to the end point of the first pack is not finished
detecting a start point of a second pack from the stopped point; and
counting from the detected start point of the second pack.

14. The method of claim 12, wherein the media contents include packs having a predetermined length,
and operation (b) comprises detecting the start point by detecting start code indicating that the packs are those relating to the media contents.

15. The method of claim 11, wherein the media contents are VOBUs (Video Object Units) recorded on a DVD.

16. An apparatus for searching for a part of media contents, the apparatus comprising:
a detecting unit detecting a start point of media contents included in multimedia contents from the multimedia contents; and
an extracting unit extracting the part of media contents based on the detected start point.

17. The apparatus of claim 16, further comprising: a counter counting from the detected start point of media contents to a start point of the part of media contents and counting from the start point of the part of media contents to an end point of the part of media contents,
wherein the extracting unit extracts media contents from the counted start point of the part of media contents to the counted end point of the part of media contents.

18. The apparatus of claim 17, wherein the media contents comprise packs having a predetermined length,
and the counter stops counting when counting of a first pack among the packs is finished in a state where counting to the end point of the first pack is not finished, and detects a start point of a second pack from the stopped point; and keeps counting from the detected start point of the second pack.

19. A computer-readable storage medium having embodied thereon a computer program for executing the method of searching for a part of media contents, the method comprising:
detecting a start point of media contents included in multimedia contents from the multimedia contents; and
extracting the part of media contents based on the detected start point.
